(19) United States
(12) Patent Application Publication
(10) Pub. No.: US 2014/0009611 A1
(43) Pub. Date: Jan. 9, 2014

(54) Camera System and Method for Observing Objects at Great Distances, in Particular for Monitoring Target Objects at Night, in Mist, Dust or Rain

(71) Applicants: Manfred Hiebl, Neuburg a.d. Donau (DE); Hans-Wolfgang Pongratz, Taufkirchen (DE)

(72) Inventors: Manfred Hiebl, Neuburg a.d. Donau (DE); Hans-Wolfgang Pongratz, Taufkirchen (DE)

(73) Assignee: EADS Deutschland GmbH, Ottobrunn (DE)

(21) Appl. No.: 13/983,456

(22) PCT Filed: Feb. 2, 2012
(86) PCT No.: PCT/DE2012/000094

§ 371 Date: Sep. 24, 2013

(30) Foreign Application Priority Data
Feb. 4, 2011 (DE) 10 2011 010 334.1

(51) Int. Cl. H04N 7/18; H04N 5/33

(52) U.S. Cl. CPC H04N 7/18; H04N 5/332
USPC 348/143

(57) ABSTRACT

A camera system and a method for the observation of objects at a large distance at night or through mist, dust, or rain, at an observation distance of 30 to 40 km, includes a pivotable target tracking mirror, a concave primary mirror with a long range, and a convex secondary mirror, which together form a reflecting telescope. The camera system also includes a Barlow lens system, an IR-sensitive image sensor arranged in the image plane of the reflecting telescope, a controllable high-speed shutter system for the image sensor, controllable IR illuminator to illuminate the object being observed by IR illumination pulses of multiple different colors, and a control device that coordinates control of the IR illuminator and of the high-speed shutter system in order to detect multispectral images captured by means of the image sensor according to a gated viewing technique.

### BACKGROUND AND SUMMARY OF THE INVENTION

Exemplary embodiments of the present invention relate to a camera system and a method for the observation of objects at a large distance, particularly for the purpose of monitoring target objects at night or in mist, dust, or rain. A “large distance” in this case means any distance greater than 5 km.

In the field of military reconnaissance, by way of example, scenarios are detected by means of multispectral sensors, particularly in a terrain being examined for the presence of facilities, persons, vehicles, infrastructure features, and the like. For this purpose, a large number of images are provided by means of multispectral surveillance cameras, wherein the images must be analyzed under pre-determined time specifications. The objects that must be recognized have any manner of dimensions, and can have a structure characterizing the object and having a complexity varying from low to high. It is possible with known systems to carry out ground reconnaissance and discovery, and ongoing ground surveillance, of a large area (e.g., a 100 km to 1,000 km border region with a depth of several km) from the air, for persons, pack animals and vehicular target objects. Multispectral cameras are typically used for this purpose and these record the data during flight if the same are installed in aircraft.

These known cameras, however, can only be used with sufficient natural illumination and sufficiently good visibility conditions, meaning little mist, dust, rain, etc. in the air.

The data is evaluated on the ground following the flight. It generally takes hours to days until the reconnaissance and discovery results are available. A real-time surveillance, 24 hours around the clock is therefore not possible, and is often prevented by poor visibility conditions.

On the other hand, video cameras, which may be equipped with discovery aids, are used for permanent surveillance of smaller areas from the air, wherein the target search and the positioning is left to the observer, and the data is simply recorded for later processing. This method is not suitable for the surveillance of large areas due to the extremely high cost, and due to the dependence thereof on good visibility conditions.

A camera for the purpose of tracking objects is known from German Patent document DE 10 2005 009 626 A1. In the case of this camera, target objects are identified by comparing the recorded image to a database. A similar method for target recognition is known from German Patent document DE 199 55 919 C1.

These known methods have the disadvantage that the recognition of targets is very slow, and only proceeds with good visibility and illumination.

One problem addressed by the present invention is reducing the dependence of the quality of observation on the current natural visibility and/or illumination conditions, for an observation of the type named above, in order to achieve a high quality of observation, particularly even with poor visibility and/or weather conditions, by way of example for military reconnaissance from the air over a large distance (e.g., more than 10 km).

The camera system according to the invention comprises:
optionally one or more pivotable target tracking mirrors for the purpose of adjusting a line of sight of the camera system;
a concave primary mirror having a focal distance of more than 1 m, and a convex secondary mirror, which together form a reflecting telescope;
optionally a Barlow lens system for the reflecting telescope;
an IR-sensitive electronic image sensor arranged in the image plane of the reflecting telescope;
a controllable high-speed shutter system for the image sensor;
controllable IR illumination means for the purpose of illuminating the object being observed by means of narrow-band IR illumination pulses in multiple different colors; and
a control device designed for coordinated control of the IR illumination means and the high-speed shutter system, in order to detect multispectral images recorded by means of the image sensor, using a “gated viewing” technique.

Exemplary embodiments of the present invention combine a high-quality reflecting telescope to detect IR (infrared) radiation with actively controllable IR illumination means, and with a controllable high-speed shutter system, for the purpose of observation, in order to thereby capture (variously colored) multiple exposure images using a so-called “gated viewing” technique.

The term “gated viewing technique” should indicate, within the scope of the invention, any coordinated control of the IR illumination means, and of the high-speed shutter system, wherein both the active illumination (by the IR illumination means) and the capturing (by the image sensor, controlled by the shutter system) are realized discontinuously, wherein this discontinuity leads to a suppression of interference light. The suppression of interference light is based on the fact that an image is captured (the shutter is open) primarily or even exclusively during the specific time frame in which the IR illumination pulse intensity reflected back from the object (and/or the target region) is expected at the position of the camera system.

In the gated viewing technique it is possible to use very short IR light pulses, by way of example, with a pulse duration in the range from 1 to 30 μs, for the purpose of illumination. The camera shutter is preferably opened each time only until the relevant echo pulse has passed the shutter integrated into the camera system. The pulse duration can be determined by a control device, for example, according to a known and/or previously determined observation distance, and can be accordingly adjusted if the observation distance changes.

The systems and methods of the present invention advantageously eliminate negative influences on the observation by means of interference light sources, as well as negative influence by means of reflections of the IR illumination beam before the same has reached the object being observed (e.g., by fog, dust, etc.). Such interfering light sources and/or unintended reflections would blind conventional cameras. In contrast, in the case of the camera system according to the invention, the “visibility range” of the observation can be improved 5 to 10 times, particularly in poor visibility. The camera system according to the invention works independently of natural illumination, which allows it to be used at night and in deep shadows or under heavy clouds.

Therefore, it is possible by means of the invention to provide a multispectral reconnaissance camera for the purpose of surveilling target objects in military applications. Particularly in such applications, the use of IR radiation is advantageous compared to the visible wavelength region because the active illumination is not perceived by the human eye, and the target observation can therefore proceed unnoticed. Particularly when relatively narrow-band IR illumination pulses are used, these can advantageously not be seen with normal night vision devices.

The present invention advantageously enables surveillance, particularly military surveillance, of target objects at a large distance of up to 40 km, by way of example, using a multispectral reconnaissance camera for the near infrared range, for use during poor visibility conditions, for example at night or when there is mist, dust, or rain. An artificial illumination, for example a multispectral laser illumination system, realizes a “gated viewing” technique when combined with the camera, to suppress interfering light. In this way, it is possible to capture multispectral images (including image sequences) of the target region, and to immediately send the same to a subsequent, automatic, computer-assisted multispectral image analysis, by way of example.

The camera system according to the invention can particularly be operated on board an aircraft (manned or unmanned) using gated viewing technology and on-board artificial illumination (e.g., a laser illumination telescope).

Due to the large potential target distance of 10 km to 40 km, by way of example, the carrier plane can operate the reconnaissance camera completely unnoticed by the target object, and can also simultaneously monitor a large space (e.g., 80 km×80 km) given sufficient visibility and sufficient flying altitude (12 km to 14 km), without need to cover large flight distances (involving high fuel consumption and therefore lower deployment time). As such, with a suitable design, it is possible to implement a system using solar power with an arbitrarily long deployment time and low operating costs (e.g., reconnaissance drones).

The problem of dependence on good visibility and illumination conditions for a reconnaissance by air over larger distances can particularly be solved by means of an NIR multispectral reconnaissance camera having the following components:
one (or multiple, sequentially arranged) target tracking and image stabilizing mirrors;
one gold-coated infrared primary mirror with a long focal distance (e.g., more than 2 m, e.g., approx. 2.54 m);
one IR Barlow lens system, e.g., a “fluorite flatfield converter” (Baader company) or the like, preferably with a 4- to 9-times focal length extension (focal distance e.g., more than 10 m, e.g., approx. 22.8 m);
a highly sensitive infrared CCD camera for the range from 0.8 μm to 1.7 μm;
an electronic high-speed shutter system which enables multiple exposures with a gated viewing technique; and
a second CCD camera with a shutter and illumination system, which can be selected via a switchable mirror when the primary mirror is focused (e.g., 2.54 m focus).

The individual components of the camera system according to the invention work together in a synergistic manner to enable a very long-range observation, even in poor visibility conditions. Particularly advantageous and therefore preferred embodiments of these components are described below in greater detail.

One or more (sequentially arranged) target tracking mirrors, controlled by the already present control device, enable a simple way of orienting the line of sight of the camera system to the target object being observed and/or the space being observed. This plays a large role particularly when the camera system is used on board a vehicle, and particularly an airplane.

In one embodiment, the target tracking mirror is connected to a rotation angle sensor to make it possible to detect alterations in the line of sight due to pivot movements of the mirror, and incorporate these into the operation of the system. The rotation angle sensor can have one or more acceleration sensors, for example, which measure accelerations which are representative for pivot movements. For applications on board an airplane, it is thereby advantageously possible to detect vibrations of the mirror being used (compared to the “inertial system”, and to use these for the control of an image stabilizer and/or de-rotation device arranged downstream in the optical beam path of the camera system.

The reflecting telescope composed of a primary mirror (“main mirror”) and secondary mirror (“capturing mirror”) is preferably a “Cassegrain” telescope in the broadest sense. By way of example, an elliptical primary mirror in combination with a spherical secondary mirror is particularly suitable. With regards to high reflectivity in the IR range, a gold coating is suitable, for example, on at least one of the two telescope mirrors. For providing good optical adjustment stability, it is advantageous if the primary mirror and secondary mirror are arranged coaxially to each other, and the beam reflected by the secondary mirror arrives at the image sensor through a central aperture of the primary mirror. The focal distance of the primary mirror can be more than 1.5 m, and particularly more than 2 m, for example.

The focal distance of the reflecting telescope, and therefore the magnification, can be advantageously increased with the Barlow lens system. Particularly when an elliptical primary mirror is used in combination with a spherical secondary mirror, a flatfield lens (for the purpose of flattening an otherwise curved image plane) should be included in the optical beam path of the camera system, for example as an integral component of the Barlow lens system.

The colors of the IR illumination pulses preferably are in the NIR (near infrared) region, meaning in the region from approx. 0.78 μm to approx. 3 μm. Once the IR colors have been determined, the further related optical system components can be designed accordingly (e.g., mirror coating(s), lens coating(s), lens materials, image sensor technology, etc.). In one preferred embodiment, the camera system is operated with NIR illumination pulses in the region from 0.8 to 1.7 μm.

In the patent literature and other publications, no applications are known that use multispectral images made particularly in the near infrared (NIR) range, using artificial illumination over larger distances (more than 5 km). However, this combination involves great advantages specifically in the near infrared region, because the transmission in the near infrared range through spaces with poor visibility is two times better than for visible light, and therefore the advantages of the gated viewing technique, with the exclusion of interfering light, are much stronger.

For the electronic image sensor in the near infrared region, an un-cooled semiconductor sensor chip can be advantageously used, preferably made of the semiconductor material indium gallium arsenide, for example, which is designed for very high NIR sensitivity compared to other wavelength ranges. An accordingly designed CCD camera, by way of example, is particularly suited for this application, wherein the image data thereof can be easily and immediately supplied to an image analysis device. Also, a matching NIR illumination device can be constructed from, by way of example, existing diode lasers available on the market.

Finally, a much greater color contrast can be analyzed for background and target object materials using the multispectral image analysis in the near infrared region rather than the medium or longer infrared regions. The result is a generally improved search result in the image analysis.

The controllable high-speed shutter system should be able to block and/or open to the incident light radiation on the image sensor within a shutter time of less than 10 μs, and preferably less than 1 μs. For the concrete embodiment of such a shutter system, the scope of the invention can include suitable electronic shutter systems according to the prior art. Such shutter systems can function, for example, according to the principle of acousto-optic or electro-optic modulators, or the like.

The controllable IR illumination means create narrow-band IR illumination pulses. Within the scope of the invention, this particularly means a wavelength bandwidth of less than 10% of an “average wavelength” (where the maximum beam intensity is found), and/or the bandwidth is smaller than 0.1 μm, and particularly smaller than 0.05 μm, and/or the spectral distributions of the differently colored spectral bands do not overlap each other.

In one embodiment that is advantageous in this regard, the IR illumination means comprise a multispectral laser system, for example an arrangement of one or preferably multiple lasers in each system, and particularly one or multiple laser diodes, for example, per illumination pulse color.

In one preferred embodiment, the IR illumination means have an integrated construction with the reflecting telescope, in such a manner that the IR illumination pulses emitted therefrom are directed through at least a part of the optical system components and onto the object being observed (wherein the IR illumination pulses in this case pass through the reflecting telescope in the “opposite direction”).

By way of example, for each illumination pulse color, an arrangement of at least five or at least ten laser diodes is included, wherein each laser diode is operated with an electrical power of at least 5 W or at least 10 W. Laser diodes are preferably used which have the technically available power of 20 to 30 W.

In one preferred embodiment, the IR illumination means each have one IR source for each of the different colors, which is planar and which is projected onto the object being observed by means of the reflecting telescope.

A planar IR source possesses the advantage of a particular spatial distribution of a potentially problematic heat production (depending on the IR generation principle used). Moreover, a planar illumination source tends to increase the robustness thereof to optical adjustments, which are required for the desired projection of the illumination source onto the object being observed.

In one particularly preferred embodiment, an IR source is used that has a surface substantially corresponding to the IR-sensitive imaging surface of the electronic image sensor (e.g., a CCD camera), and which is coupled into the system via an input coupling mirror (e.g., a semi-transparent or “on demand” clocked mirror—e.g., a segmented mirror or polygonal mirror, etc.) arranged in the optical beam path of the reflecting telescope and/or camera system, in order that the IR radiation from the source passes through at least a part of the camera system components (particularly the primary mirror and the secondary mirror, and optionally the Barlow lens system) in the “opposite beam path direction”. With respect to the optical design and/or the robustness of the image quality with respect to vibrations, temperature variations, etc., it is particularly advantageous if the distance between the input coupling mirror and the IR source corresponds to the distance between the input coupling mirror and the image sensor. In this case, it is possible to use one optical system for both the (true) imaging of the object being observed on the image sensor, and also the projection (in the opposite direction) of the IR source onto the object being observed.

In one preferred embodiment, the planar IR source is an arrangement of multiple laser diodes, or more preferably an arrangement of the ends of optical fibers (e.g., fiberglass cables), wherein the radiation of one or more laser diodes is coupled into each of the other ends thereof. For such a grid-like arrangement of laser diodes and/or optical fibers, by way of example, a very uneven intensity distribution of the emitted IR radiation typically results. In order to avoid a resulting, accordingly uneven illumination of the object being observed, two measures particularly can be used, either individually or in combination:

First, a diffuser element, for example, can be used on the surface of the IR source in order to achieve an evening of the beam power across the beam-generating surface, right at the point of the IR illumination generation.

As an alternative or in addition thereto, a particularly simple measure can be projecting the IR source in an “unsharp” manner onto the object being observed, meaning allowing a certain “defocusing” of this image in such a manner that the individual intensity maxima of the IR source surface are each projected onto the object over a larger area, in a “smeared” manner. This defocusing preferably occurs to such a degree that local maximum illumination intensities (powers) are achieved across the surface of the object being observed which are in any case twice as great as the local minimum illumination intensity at the region of the object.

In one embodiment, the IR illumination means are an artificial NIR illumination system, consisting of one laser illumination group for each illumination wavelength, the groups consisting of multiple (e.g., 10 to 30) laser diodes with collimation lenses, the laser diodes fully covering the image surface at the focus position of the true image of the target object with collimated, focused light, at the size of the CCD chip serving as the image sensor.

In the artificial NIR illumination system, the multiple (e.g., 3 or 4) laser illumination groups, with their differing wavelengths, can be coupled into the optical beam path of the NIR reflecting telescope, particularly via semi-transparent mirrors that only reflect in the assigned wavelength region. In this way, it is possible to use multiple illumination wavelengths without multiplying the amount of light lost. In this case, the NIR observation telescope is effectively additionally used as an “NIR projection telescope” with a long focal distance, in an advantageous manner.

An image stabilizer and/or de-rotation device, as mentioned above, can be included, preferably in the optical beam path between the reflecting telescope (and optionally the Barlow lens system) and the electronic image sensor. The high-speed shutter system is preferably positioned directly in front of the electronic image sensor and/or is integrated into the construction thereof.

In one implementation of the invention, the camera system further has a second electronic image sensor, wherein the camera system can be switched over to the same, such that the image is captured by this second image sensor. The switching can be carried out by means of, for example, an electronically switchable mirror, or an “on demand” mirror activated in another manner, wherein the mirror deflects the IR radiation detected by the camera system to a specific point of the optical design on the second image sensor. This is particularly advantageous if this “output coupling point” and/or position of the second image sensor is chosen in such a manner that the focal distance of the camera system changes at this position—that is, can be switched. By way of example, this can implement a change in the system focal distance of at least a factor of 2, and preferably at least a factor of 5. One constructive implementation that is particularly simple in this regard involves including the output coupling mirror for the second image sensor in the optical beam path of the camera system between an aperture of the primary mirror and a Barlow lens system.

The observation method according to the invention can be advantageously carried out at a distance, measured between the camera system and the object being observed thereby, of at least 10 km, by way of example, and particularly at least 20 km.

The method can particularly be carried out in poor visibility conditions (e.g., less than 5 km with the human eye).

Observation from an elevated observation position, e.g., from a height of more than 5 km, is advantageous. By way of example, the observation can take place from a height of 12 km to 14 km, for example, at an observation distance (between the camera system and the object being observed) of 30 to 40 km, in order to realize the range advantage which is possible with the gated viewing technique.

The IR illumination means are preferably controlled in such a manner that the duration of each of the IR pulses is less than the time required for the transit of the distance from the camera system to the object being observed. This limitation of the maximum pulse duration makes allowance for the fact that the detection of the “start of the pulse” already reflected by the object by the camera system, given the integration therein of IR illumination means, would typically fail if the “end of the pulse” of the same pulse has not yet left the camera system at this point in time. In the latter case, the image sensor in practice would already be blinded and/or overloaded by very small undesired reflections and/or backscatter of the IR radiation power inside the camera system, such that a simultaneous imaging of the radiation reflected by the object would be impeded.

On the other hand, the duration of the IR pulse should also not be too short, so that at a given IR radiation power of the IR illumination means, the greatest possible radiation energy can be “packed” into each illumination pulse, and/or “dead times” in the system operation can be kept as short as possible. In one embodiment, therefore, the IR illumination means are preferably controlled in such a manner that the duration of each of the IR pulses is greater than 40%, and particularly greater than 60%, of the time required for the transit of the distance from the camera system to the object being observed.

The IR illumination means can be controlled in such a manner that the differently colored IR illumination pulses can be emitted in an alternating cycle.

As mentioned above, a simultaneous emission of IR illumination radiation and capturing of reflected “usable radiation” should be avoided by the camera system. For this reason, in a preferred operation, first an IR illumination pulse is emitted, and then the reflection from the object is captured by the electronic image sensor—always in alternation and never coincident in time. The high-speed shutter system functionally assigned to the image sensor in this case is preferably controlled in such a manner that the shutter is only opened during periods in which IR illumination radiation reflected by the object is expected at the position of the camera system (These periods are determined in a trivial manner using the known and/or determined distance of the object from the camera system, taking into account the speed of light).

The images captured by the electronic image sensor can be, for example, immediately sent to a computer-based automatic image analysis process.

### BRIEF DESCRIPTION OF THE DRAWING FIGURES

The invention is described in greater detail with reference to one embodiment in the context of the attached drawings, wherein:

FIG. 1 shows the optical design of a camera system according to one embodiment of the invention; and

FIGS. 2 and 3 show the optical design (FIG. 2) and/or the construction (FIG. 3) of IR illumination means of the camera system in FIG. 1.

### DETAILED DESCRIPTION

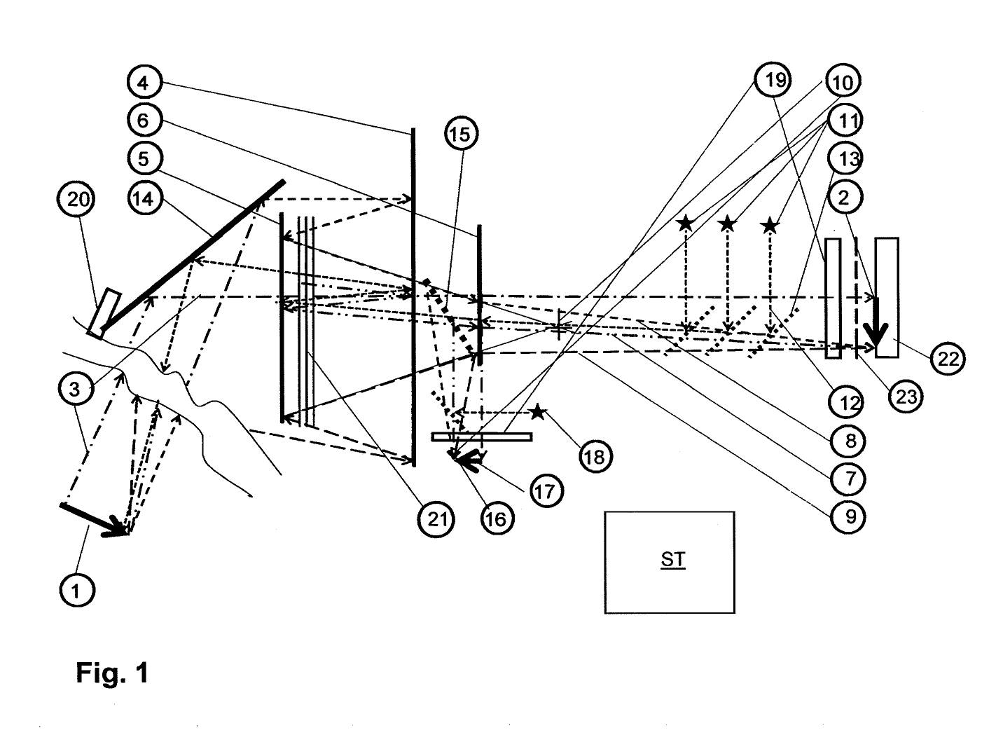

FIG. 1 shows one embodiment of a multispectral reconnaissance camera, with its own artificial illumination.

A sufficiently illuminated target object 1 at a large distance (10 to 40 km) is homed on along a line of sight 3 by a telescope 4, 5, and 6, and generates a true image 2 of the target object 1 on the indium gallium arsenide CCD chip of a CCD camera 22 for the near infrared region (sensitive from 0.8 μm to 1.7 μm, with a size of 9.6 mm×7.7 mm, pixel size 30 μm, image size 320 columns by 250 rows).

The telescope 4, 5, 6 consists of a gold-coated, elliptical primary mirror (“main mirror”) 4 with a diameter of 32 cm (12.5 inches) and a focal distance of 2.54 m, a gold-coated, spherical secondary mirror (“capturing mirror”) 5 in a Cassegraine arrangement, and a special Barlow lens 6, in this case the “fluorite flatfield converter” (from the Baader company), which lengthens the focal distance of the primary mirror 4 adjustably from 4- to 9-times (max 22.86 meters), and also generates a flat, fully color-corrected infrared image in the complete focal distance position.

The optical beam path of the radiation from the object 1 arriving in the camera system is indicated in FIG. 1 by the upper boundary ray 8, lower boundary ray 9, and central ray 7. The optical elements, such as the primary mirror 4, secondary mirror 5, and the Barlow lens 6 are each illustrated in FIG. 1 by their principal plane.

The light intensity of the camera system and/or the telescope 4, 5, 6 is designed in such a manner that sufficiently low-noise images of the target object 1 are generated on the light-sensitive surface of the CCD camera 22.

During the operation of the camera system, 4 to 30 IR illumination pulses 12 are generated and transmitted per image, by way of example (multiple exposures). The illumination pulses 12 each have a duration of 30 μs and a light power of approximately 400 W.

The illumination pulses 12 are generated by means of laser illumination devices 11, and projected through the telescope 6, 5, 4 coaxially to the line of sight of the CCD camera 22 via a semi-transparent mirror 13 onto the target object 1.

The images captured by the CCD camera 22 by the reflection of the IR radiation at the object 1 are read by the camera electronics and transmitted as digital images to an analysis computer (not shown).

The usable illumination time per image can be increased by a factor of 30 at a distance of 40 km by emitting an illumination pulse of the same color every 0.33 μs during each 10 ms period of time dedicated to the image capture, wherein the echo of each illumination pulse arrives back at the camera system before the next illumination pulse, thereby executing multiple exposures for each image.

A qualitatively straightforward multiple exposure approach requires that the stabilization of the line of sight during the 10 ms is good enough such that no image blurring occurs.

A blocking filter 21 that only allows the passage of the 3 laser lines (bandwidth: 0.02 μm, for example) is used in the optical beam path of the illumination pulse 12, which in this case is between the primary mirror 4 and the secondary mirror 5. This configuration achieves a maximum suppression of scattered light from the surroundings.

The semi-transparent mirrors 13 are designed with such a narrow bandwidth (0.02 μm) that they only reflect the laser pulse of their dedicated color, and are otherwise transparent. In this way, it is possible to introduce multiple laser colors, e.g., 3, one after the other into the telescope beam path without increasing the light loss at the semi-transparent mirrors.

The opening time of a camera shutter 23 is synchronized with a “clocking” of the illumination pulse 12 in such a manner that the echo of each illumination pulse can just barely pass through the shutter 23, and all the scattered light reaching the camera system before or after the echo pulse is gated out (the gated viewing process).

A multispectral illumination is triggered in such a way that laser pulses 12 are emitted with different wavelengths for each image following directly one after the other (e.g., 100 images per second), wherein the wavelengths are determined in such a manner that they each lie in a different, easily transparent atmospheric window, on the one hand, while on the other hand they are well reflected by the target object material, they produce a good color contrast for different materials, and they can preferably also be delivered as laser wavelengths.

The selected wavelengths in the illustrated example are 0.98 μm, 1.48 μm, and 1.55 μm, by way of example. For wavelengths of 1.5 μm, the transmission in humid air with 0.82 through air with 200 mm of separable water along the path of observation (which is a highly common value) is twice as great as for wavelengths of 0.5 μm.

In conditions of rain, mist, and blowing sediments, when back-glare caused by the illumination presents a very serious visibility obstacle, the range of the camera system can be up to 10 times as great, due to the gated viewing method used here.

The camera system is installed on board an aircraft. A typical situation for deployment is a flight altitude of 13 km and a distance from the target of 40 km. Typically, clouds of blown sediment rise particularly to 1 to 4 km in the air, and in extreme cases result in a transmission value for simple, perpendicular downward transmission (3 km) of 0.9 as a result of the dust.

At a doubly inclined transmission with a resulting path length of approximately 18 km, an approximate transmission value of 0.53 results. The illumination is strong enough for these conditions, but without the gated viewing technique, the echo signal would be overlapped by scattered light from the pulse travel distance which would be more than 5 times as strong, and therefore would be invisible.

For deployment in an aircraft, the telescope should be equipped with a target tracking and image stabilizer mirror system 14. For the target tracking, the line of sight 3 is always directed toward the target object being imaged.

The control of all of the controllable components of the camera system, such as the mirror system 14, the laser illumination device 11, the Barlow lens system 6, and the camera shutter 23 in particular is carried out by an on board central control device ST.

The telescope should additionally be secured against vibrations of the support system by means of a high-frequency double axis line of sight stabilization. In the illustrated example, this consists of one image stabilization wedge prism with a de-rotation device 19 prior to the CCD camera in each case, which is controlled by a shared line of sight angular rotation measuring device 20 mounted on the outermost target tracking mirror 14 and which measures the movement of the line of sight 3 in space in two axes.

The multispectral reconnaissance camera can, when controlled by means of the control device ST, be selectively operated with different focal distances, without using moving parts in the process. The switching for this purpose is carried out in several seconds via an electronically switchable mirror 15. The same reflects the beam travelling along line of sight 3 from the primary mirror 4, with the focal length 10 (in this case: 2.54 m) to a position 16. At this point there is a second NIR CCD camera 17, with a second illumination device 18 (or multiple such illumination devices), matched to the 2.54 m range and the 10 km observation distance, with a corresponding lower beam power.

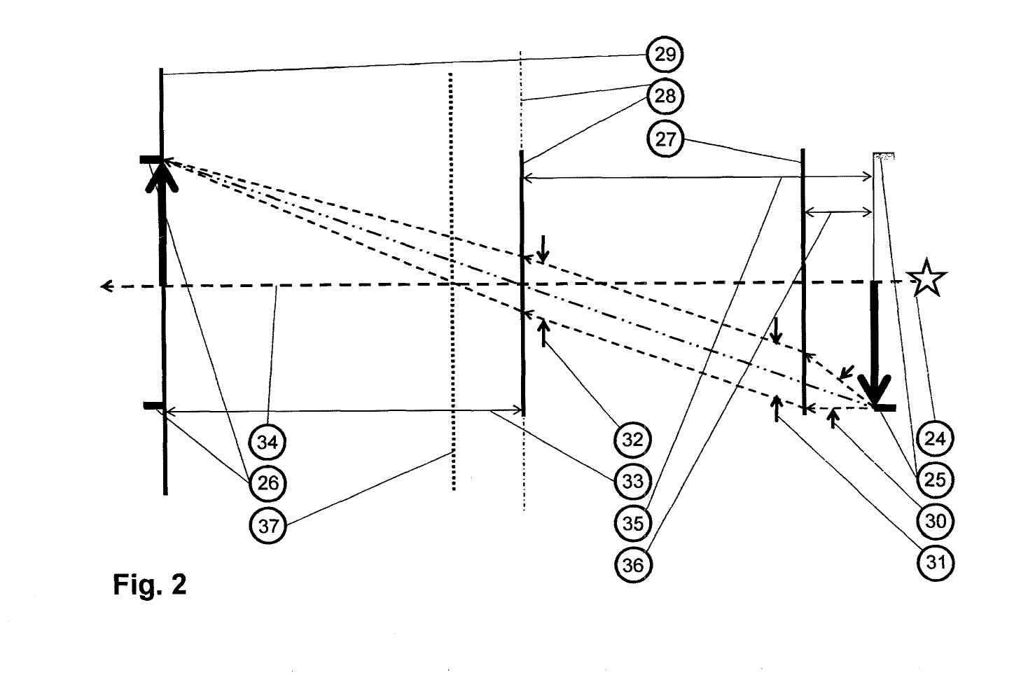

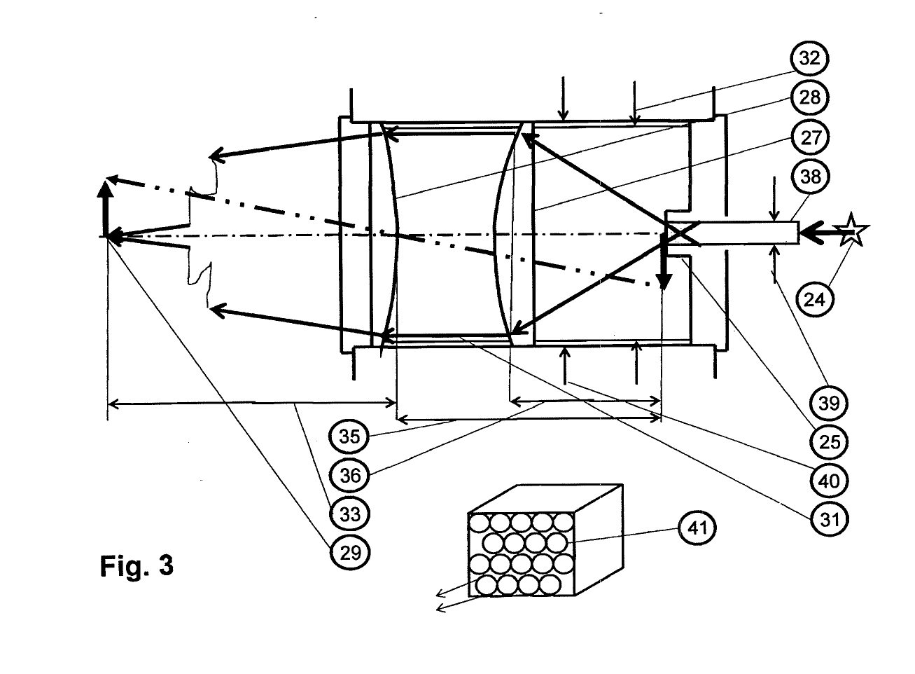

FIGS. 2 and 3 show the multispectral illumination system implemented in the multispectral reconnaissance camera illustrated in FIG. 1 in greater detail. Again, FIG. 2 only shows the principle of the optical design, while in FIG. 3 some of the optical components as such are illustrated.

The light sources of the IR illumination system in the present system are three groups of 18 diode lasers 24 each, for each of the wavelengths named above (0.98 μm; 1.48 μm; 1.55 μm), particularly with a light power of 20 to 30 W, and with an optical fiber output coupling 38 having a diameter 39 (FIG. 3) of preferably approximately 0.375 mm.

The exit pupil 25 of the optical fiber arrangement and/or the optical fiber output coupling 38 is arranged in the focus position of the true object image in the relevant illumination device. At this position, one holder for each spectral color, the holder having the frontal dimensions of the CCD chip (9.6×7.7 mm), is attached on the end face, which has 18 drilled holes 41 (see the sub-drawing in FIG. 3, below) each with a diameter of 1.8 mm. In each drilled hole, one output coupling lens (as shown in the principal illustration in FIG. 3) is inserted for each of the optical fibers of the optical fiber arrangement 38 (FIG. 3).

The laser beam exits the output pupil 25 with a 0.375 mm diameter, and a divergence angle 30 (FIG. 2) of 16.2°. This is converted by means of a lens 27 (FIG. 2 and FIG. 3) into a collimated parallel beam 31 (FIG. 2 and FIG. 3) with a diameter 32 (FIG. 2 and FIG. 3) of 1.7 mm. The optical fiber collimation lens has an aperture diameter 40 (FIG. 3).

This parallel beam is projected by a further lens 28 (FIG. 2 and FIG. 3) onto the primary mirror 4 (diameter 32 cm and/or 12.5 inches) (see also position 26 in FIG. 2 and FIG. 3 as output pupil 26 (FIG. 2) at a focal distance 33 (FIG. 2 and FIG. 3) of 22.86 m. In this way, a so-called critical illumination system is realized which projects the illumination energy of multiple light sources onto the target object, theoretically without loss (no transmission losses). A Barlow lens system (and/or “fluorite flatfield converter”) 37 (FIG. 2) is arranged in the illumination beam path.

A focus length 36 (FIG. 2) of the lens 27 (FIG. 2 and FIG. 3) is 5.98 mm in this case. A mounted distance 36 (FIG. 3) which essentially corresponds thereto is 5.96 mm. A mounted distance 35 (FIG. 2 and FIG. 3) of the second lens 28 can be freely selected within certain limits.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMBERS

1 target object

2 true image (of the target object)

3 line of sight

4 primary mirror

5 secondary mirror

6 Barlow lens system and/or fluorite flatfield converter

7 central ray

8 upper boundary ray

9 lower boundary ray

10 focus length

11 laser illumination devices

12 illumination pulses

13 semi-transparent mirror

14 target tracking mirror

15 electronically switchable mirror

16 position

17 second CCD camera

18 second illumination device(s)

19 image stabilizer and de-rotation device

20 angular acceleration measuring device

21 blocking filter

22 CCD camera

23 high-speed shutter system

ST electronic control device

24 laser diodes

25 optical fiber output pupil

26 primary mirror output pupil

27 first collector lens

28 second collector lens

29 position of the primary mirror

30 divergence angle

31 collimated parallel beam

32 diameter of the parallel beam

33 focal distance

34 optical axis

35 mounted distance

36 focal length (of the first collector lens)

37 Barlow lens system and/or fluorite flatfield converter

38 optical fiber arrangement

39 diameter and/or cross-wise expansion

40 aperture diameter of the optical fiber collimation lens

41 optical fiber ends

1-10. (canceled)

11. A camera system for the observation of objects at a distance of more than 5 km, at night or in mist, dust, or rain, comprising:
a reflecting telescope formed by a concave primary mirror having a focal distance of more than 1 m, and a convex secondary mirror;
an infrared-(IR) sensitive electronic image sensor arranged in an image plane of the reflecting telescope;
a controllable high-speed shutter system for the IR-sensitive electronic image sensor;
a controllable IR illumination device configured to illuminate the object being observed, wherein the controllable IR illumination device is configured to emit narrow-band IR illumination pulses in multiple different colors; and
a control device configured to coordinate control of the IR illumination device and of the high-speed shutter system using a gated viewing technique to detect multispectral images recorded by means of the IR-sensitive electronic image sensor.

12. The camera system according to claim 11, further comprising:
one or more pivotable target tracking mirrors configured to adjust a line of sight of the camera system.

13. The camera system according to claim 11, further comprising:
a Barlow lens system configured for the reflecting telescope.

14. The camera system according to claim 11, wherein the colors of the IR illumination pulses lie in the near infrared (NIR) range.

15. The camera system according to claim 11, wherein the primary mirror is elliptically curved and the secondary mirror is spherically curved.

16. The camera system according to claim 11, wherein the IR illumination device comprise a multispectral laser system.

17. The camera system according to claim 11, wherein the IR illumination device has one planar IR source for each of the different colors, which is projected onto the object being observed by means of the reflecting telescope.

18. A method for the observation of objects at a distance of more than 5 km, at night or in mist, dust, or rain, by means of a camera system, the method comprising:
illuminating an object being observed using an IR illumination device using narrow-band IR illumination pulses of multiple different colors;
controlling the IR illumination device and a high-speed shutter system using a gated viewing technique to detect multispectral images recorded by means of an IR-sensitive electronic image sensor,
wherein the IR-sensitive electronic image sensor is arranged in a plane of a reflecting telescope that includes a concave primary mirror having a focal distance of more than 1 m, and a convex secondary mirror.

19. The method according to claim 18, further comprising:
adjusting a line of sight of the camera system using one or more pivotable target tracking mirrors.

20. The method according to claim 18, wherein the method is carried out at a distance, measured between the camera system and the object being observed, of at least 10 km.

21. The method according to claim 18, wherein the method is carried out at a distance, measured between the camera system and the object being observed, of at least 20 km.

22. The method according to claim 18, wherein the IR illumination device is controlled in such a manner that a duration of each of the IR illumination pulses is less than a time required for transit of a distance from the camera system to the object being observed.

23. The method according to claim 18, wherein the IR illumination device is controlled in such a manner that a duration of each of the IR illumination pulses is greater than 40% of a time required for a transit of a distance from the camera system to the object being observed.

24. The method according to claim 18, wherein the IR illumination device is controlled in such a manner that a duration of each of the IR illumination pulses is greater than 60% of a time required for a transit of a distance from the camera system to the object being observed.

25. The method according to claim 18, wherein the IR illumination device is controlled in such a manner that the differently colored IR illumination pulses are emitted in an alternating cycle.
